(19) United States
(12) Patent Application Publication
(10) Pub. No.: US 2019/0358991 A1
(43) Pub. Date: Nov. 28, 2019

(54) FILE, AND FILING MECHANISM

(71) Applicant: OKAMURA YUGEN KAISHA, Osaka (JP)

(72) Inventor: Toshio OKAMURA, Hyogo (JP)

(21) Appl. No.: 15/740,211

(22) PCT Filed: Jun. 29, 2017
(86) PCT No.: PCT/JP2017/024021

§ 371 Date: Dec. 27, 2017

(30) Foreign Application Priority Data
Jun. 1, 2017 (JP) PCT/JP2017/020466
Jun. 9, 2017 (JP) PCT/JP2017/021487

(51) Int. Cl. B42F 9/00

(52) U.S. Cl. CPC B42F 9/002; B42F 9/007

(57) ABSTRACT

A file (1) includes: a cover member (2); a base plate (4) fixed to the inner surface of the cover member (2); first and second rod members (5, 6) standing vertically and mutually parallel on the base plate (4) with a certain gap between them; a pressure plate (7) orthogonal to the rod members (5,6) for pressing an object to be filed (S) toward the base member (4), through which the rod members (5, 6) pass, and that is shiftable so as to approach toward and recede from the base plate (4); and a locking mechanism (8) that is capable of locking the pressure plate (7) with respect to at least one of the rod members (5, 6) at any desired position in the longitudinal direction of the rod members (5, 6), so that it cannot shift in the direction to recede from the base plate (4).

### TECHNICAL FIELD

The present invention relates to a file and to a filing mechanism, with which it is possible to perform filing by pressing one or more pressure plate on an object to be filed, such as documents or the like, without forming any punched hole in the object.

### BACKGROUND ART

Various ring files and so on are commercially available as such files of a type with which two or more punched holes are formed at the left edge portion of the object by using a two hole punch, and rod members or ring members are passed through these punched holes.

With this sort of ring file and so on, it is necessary to open holes in a document with a punch in order to file the document, and, in the case of a document whose thickness is great, it is necessary to punch such holes a large number of times so that the task of forming these holes and filing the document takes a long time; and, moreover, when one desired document is to be extracted from among documents that have been filed, often it is difficult to extract only the desired document, and, after having extracted the desired document along with neighboring documents, it is often necessary to refile the neighboring documents.

Thus, when filing is performed using punched holes, the cost entailed by the filing becomes very great, and this causes a decrease in productivity. Moreover, there is often a demand for filing various important documents such as catalogs, pamphlets, photographs, illustrations, maps, drawings, trial evidence documents and so on without punching holes in them. Accordingly, there has long been a demand for a type of file with which it is possible to file documents whose thickness is around 30 mm or more without punching holes in them, but as yet no such file has been implemented in practice.

For example, the lever file described in Patent Document #1 and the binder described in Patent Document #2 are known as types of files in which documents can be filed without punching holes in them. The lever file of Patent Document #1 has a construction with which documents are fixed by a pressure plate and a parallel link due to the elastic force of a torsion spring that is elastically deformed by a lever, but the maximum thickness of a document that can be filed is less than 30 mm.

The binder of Patent Document #2 has been previously proposed by the inventor of the present application, but has not yet been implemented in practice. This binder comprises a base plate, two rod members, an elastic plate, and two locking members that are rotatably attached to the upper surface of the elastic plate; and two holes through which the two rod members are passed are formed in the elastic plate, with barrel portions through which the rod members are passed being formed on the elastic plate at the locations of these holes, and accordingly the elastic plate is guided by these barrel portions so as not to tilt.

A plurality of engagement teeth are formed at small pitch in two rows on both the front and the rear surfaces of the rod members respectively, and each locking member has a pair of locking claws that are formed on both sides of a cutaway portion. When filing is to be performed, the object to be filed is pressed via the elastic plate, and each of the locking members is then rotated so that its pair of locking claws are engaged with the engagement teeth on both the front and rear sides, and thereby shifting upward of the elastic plate is prevented.

Apart from the above, the files and binders described in Patent Documents 3 through 5 have also been proposed.

### PRIOR ART DOCUMENT

### Patent Document

Patent Document #1: Japanese Laid Open Patent Publication 2003-335087. Patent Document #2: Japanese Patent Publication 4,415,940. Patent Document #3: Japanese Laid Open Patent Publication 2007-125721. Patent Document #4: Japanese Utility Model Registration 3,144,270. Patent Document #5: International Laid-Open Publication WO2006/131982.

### SUMMARY OF INVENTION

### Technical Problem

With the file of Patent Document #1, in order to make it possible to file a thick object for filing, it is necessary to provide a large lever, a large and powerful torsion spring, and a large parallel link, and therefore the manufacturing cost becomes high because especially a powerful torsion spring is rather expensive. Moreover the left edge portions of documents which are narrow regions are clamped, accordingly there are limits to gripping thick documents.

And the binder of Patent Document #2 is subject to problems as follows. Considering only a single rod members, since the construction exerts a pressing force on the object to be filed with an elastic plate via a single rod member which stands near the end portion of the object to be filed, accordingly it is very difficult to enhance the rigidity and the strength of the construction that presses on the document with the rod member and the elastic plate. If the rod member is sufficiently thick and its base end portion is solidly fixed to a thick base plate, then the size of the construction becomes large and the manufacturing cost becomes high, and moreover the large sized elastic plate is also expensive.

With a construction in which a large pressing force acts via two rod members that are arranged to the front and rear locations, thus supporting an elastic plate in a cantilever manner, there is an unbalance in the designed appearance and an intuitively recognizable unreasonableness. The binding mechanism of Patent Document #5 has similar problems to those of Patent Document #2.

With a construction in which an object to be filed is pressed by screwing a fastening nut onto a rod member that consists of a threaded rod and then tightening the fastening nut, as in the case of the binders of Patent Documents #3 and #4, it takes considerable time to attach and detach an object to be filed.

With this type of prior art pressure type file, constructions have been contemplated in which falling out of the filed object is prevented only by the frictional force acting on the lower surface and the upper surface of the object. However, with objects for filing whose thickness is large or with high quality objects for filing having low friction surfaces, the frictional force described above has been insufficient, and it has been difficult to prevent falling out of the object after filing.

Objects of the present invention are: to provide a file and a filing mechanism, with which a pressure plate is shiftably installed to two rod members that stand vertically and mutually parallel at the left edge portion of a base plate, spaced apart by a small gap in the width direction (the left to right direction) of an object to be filed, with the rigidity and the strength being greatly improved; and to provide a file and a filing mechanism that incorporate one or more friction plates of a simple construction that is capable of generating at least a portion of the frictional force required in order to hold a filed object in a hanging state.

### Means to Solve the Problem

The present invention presents a file for filing an object to be filed such as a document or the like, characterized by comprising: an cover member comprising a front cover, a side cover and a rear cover; a base plate fixed to an inner surface of the rear cover; a first rod member that extends vertically with respect to the base plate from a first end portion that is fixed at a first location on the base plate; a second rod member that extends vertically with respect to the base plate from a second end portion that is fixed at a second location on the base plate that is spaced by a certain gap toward the side cover from the first location; a pressure plate for pressing the object to be filed toward the base member, having first and second guide holes through which the first and second rod members respectively pass, and shiftable parallel to itself so as to approach toward and recede from the base plate while maintaining an attitude substantially orthogonal to the first and second rod members; and a locking mechanism that is capable of locking the pressure plate with respect to at least one of the first and second rod members at any desired position in a longitudinal direction of the first and second rod members, so that the pressure plate cannot shift in the direction to recede from the base plate.

Since, according to the structure described above, a structure is provided in which the first and second rod members are erected on the base plate with a certain gap between them, the first and second rod members are passed through the first and second guide holes in the pressure plate, and the pressure plate can approach toward and recede from the base plate while maintaining an attitude substantially orthogonal to the first and second rod members, accordingly it is possible to keep the pressure plate in a state of being almost orthogonal with respect to the first and second rod members, in a stable manner. And, via the first and second rod members, it is possible to enhance the rigidity and the strength of the construction with which the object to be filed is pressed by the pressure plate, it is possible to enhance the performance for guiding the pressure plate so that it shifts while remaining parallel to itself, and it is possible remarkably to enhance the performance for filing by pressing on the object to be filed with the pressure plate. Moreover unreasonableness in design is eliminated, and unbalance in external appearance is also canceled.

As first preferable aspect, the file may comprise a support member that is fixed to the rear cover or to the base plate, and may comprise one or a plurality of friction plates, each comprising an engagement portion capable of being linked to the support member at one end portion towards the side cover, and each being capable of being sandwiched between the object to be filed in a state in which the engagement portion is linked to the support member, and capable, in a state of being sandwiched between the objects to be filed, of generating at least a portion of a frictional force that holds the filed object when the filed object are held in a hanging state in a vertical attitude.

It is possible to strengthen the friction force that holds the objects to be filed so that they do not fall down, since, according to the structure described above, in the filed state in which the object to be filed are also pressed by the friction plate, and frictional force is also generated between both sides of the friction plate and the objects to be filed.

As second preferable aspect, the first rod member may have an outer peripheral surface including a planar receiving surface capable of receiving and stopping an edge portion of the object to be filed and a partial cylindrical surface; the locking mechanism comprises a screw portion having a discontinuous helicoid shape including a plurality of screw threads formed on the partial cylindrical surface, an actuation member installed on the pressure plate, and a through hole formed in the actuation member so as to pass the first rod member, the through hole having one or a plurality of circular arcuate engagement teeth at a part of its internal circumferential portion that are capable of engaging with the screw portion; and in a state in which the one or a plurality of engagement teeth are opposing the receiving surface, the actuation member and the pressure plate can be shifted with respect to the first rod member along the longitudinal direction of the first rod member, and, in the state in which the engagement tooth and the screw portion are mutually engaged, the actuation member and the pressure plate are locked with respect to the first rod member, so as not to be able to shift in the direction away from the base plate.

According to the structure described above, in a state in which the one or a plurality of engagement teeth are opposing the receiving and stopping surface, it is possible to remove the object to be filed that has been filed by appropriately shifting the actuation member and the pressure plate. And thereafter the locked state is established when, in the state in which the object to be filed is pressed by hand via the actuation member and the pressure plate, the actuation member is rotated and the engagement tooth or teeth are engaged with the screw portion. When this locked state has been established, by rotating the actuation member in the rightward screwing direction, the pressing force may be strengthened due to the operation of the screw portion.

Further, the present invention presents a filing mechanism for filing an object to be filed such as a document or the like, characterized by comprising: a base plate; a first rod member that extends vertically with respect to the base plate from a first end portion that is fixed at a first location on the base plate, and formed with a receiving surface on a side surface portion for receiving and stopping an edge portion of the object to be filed; a second rod member that extends vertically with respect to the base plate from a second end portion that is fixed at a second location on the base plate that is spaced by a certain gap from the first location in the opposite direction to the receiving surface; a pressure plate for pressing the object to be filed toward the base member, having first and second guide holes through which the first and second rod members respectively pass, and shiftable parallel to itself so as to approach toward and recede from the base plate while maintaining an attitude substantially orthogonal to the first and second rod members; and a locking mechanism that is capable of locking the pressure plate with respect to at least one of the first and second rod members at any desired position in a longitudinal direction of the first and second rod members, so that it cannot shift in the direction to recede from the base plate.

This filing mechanism provides similar advantages to the file of the present invention, since it is a device that is almost the same as the file of the present invention, with the cover member eliminated.

### Advantages of Invention

According to the present invention, various advantages are obtained as described above.

### BRIEF DESCRIPTION OF DRAWINGS

FIG. 1 is a perspective view of a file according to an embodiment of the present invention;

FIG. 2 is a plan view of the file;

FIG. 3 is an elevation view of essential portions of the file;

FIG. 4 is a vertical sectional view of essential portions of a filing mechanism;

FIG. 5 is a vertical sectional view of essential portions of the filing mechanism (release position);

FIG. 6 is a horizontal sectional view of essential portions of the filing mechanism (release position);

FIG. 7 is a vertical sectional view of essential portions of the filing mechanism (locking position);

FIG. 8 is a horizontal sectional view of essential portions of the filing mechanism (locking position);

FIG. 9 is a plan view of a friction plate;

FIG. 10 is a plan view of essential portions of a friction plate of a first variant;

FIG. 11 is a plan view of essential portions of a friction plate of a second variant;

FIG. 12 is a plan view of essential portions of a friction plate of a third variant;

FIG. 13 is a vertical sectional view of essential portions of a file in a state in which first and second rod members are elastically deformed;

FIG. 14 is a horizontal sectional view of essential portions in a locking mechanism of a first variant example;

FIG. 15 is a horizontal sectional view of essential portions in a locking mechanism of a second variant example;

FIG. 16 is a horizontal sectional view of essential portions in a locking mechanism of a third variant example;

FIG. 17 is a horizontal sectional view of essential portions in a locking mechanism of a fourth variant example;

FIG. 18 is a vertical sectional view of essential portions in the locking mechanism of the fourth variant example;

FIG. 19 is a plan view of essential portions in a locking mechanism of a fifth variant example;

FIG. 20 is a vertical sectional view of essential portions in the locking mechanism of the fifth variant example;

FIG. 21 is a vertical sectional view of essential portions in a locking mechanism of a sixth variant example;

FIG. 22 is a vertical sectional view of first and second rod members and a base plate of a seventh variant example;

FIG. 23 is an elevation view of first and second rod members of an eighth variant example;

FIG. 24 is a plan view of a locking mechanism of a ninth variant example;

FIG. 25 is a vertical sectional view of the locking mechanism of FIG. 24;

FIG. 26 is a partial enlarged view of a construction in which portions of an actuation member and a pressure plate shown in FIG. 25 have been altered;

FIG. 27 is a plan view of essential portions of a file and a friction plate of a tenth variant example; and

FIG. 28 is a horizontal sectional plan view of essential portions in a locking mechanism of an eleventh variant example.

### DESCRIPTION OF EMBODIMENTS

In the following, an embodiment of the present invention will be explained with reference to the drawings.

The file 1 of this embodiment is a file for filing an object to be filed such as documents or the like (hereinafter termed as “document S”). This file 1 comprises a cover member 2 that includes a front cover 2a, a side cover 2b, and a rear cover 2c, and two filing mechanisms 3 that are attached to the cover member 2. This file 1 is an example of a file for filing document S of A4 size, but it may also be applied to filing document S of various sizes other than A4 size. The cover member 2 is formed from plate like members made of cardboard or of synthetic resin.

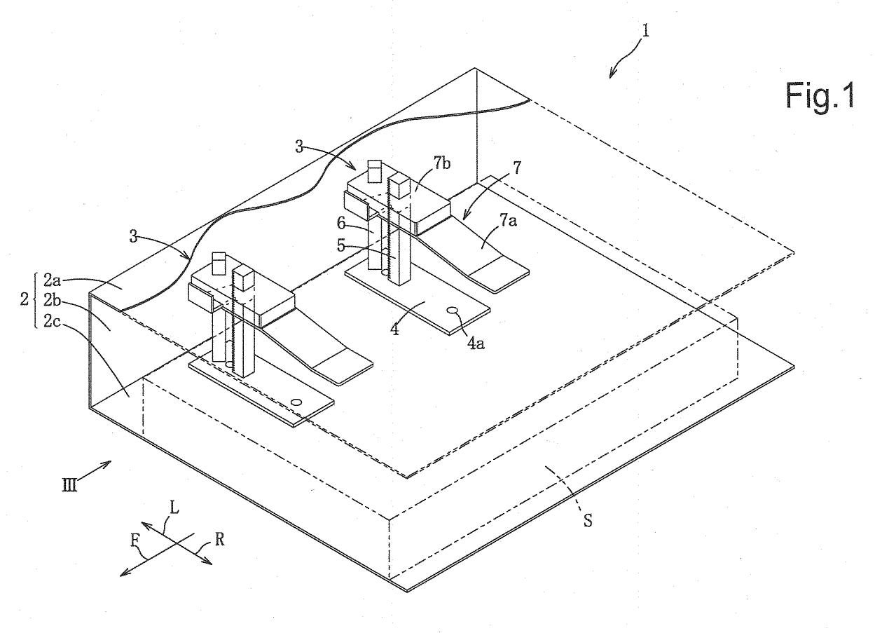

In the following explanation, it will be assumed that the file 1 is in a horizontal attitude in which documents can be attached thereto and detached therefrom, with the arrows F, L, and R indicating front, left, and right respectively, as shown in FIG. 1. Moreover, the left-right direction is the horizontal width direction of the document S (i.e. the horizontal width direction of the rear cover 2c), and the front-rear direction is the longitudinal direction of the document S (i.e. the longitudinal direction of the rear cover 2c).

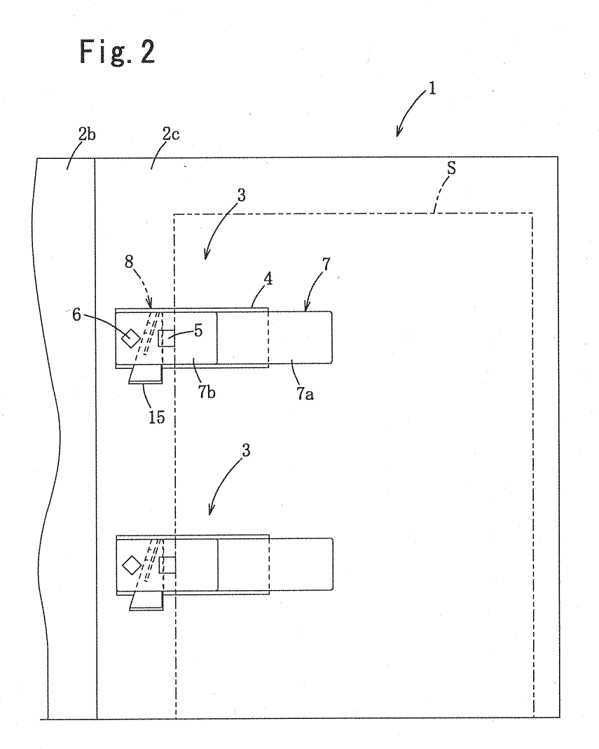

As shown in FIGS. 1 through 4, the two filing mechanisms 3 have the same construction, and are fixed to the front portion and to the rear portion of the left side portion of the inner surface of the rear cover 2c. Each of the filing mechanisms 3 comprises a base plate 4 made from metal, first and second rod members 5, 6 that are attached to the base plate 4, a pressure plate 7, a locking mechanism 8, one or a plurality of thin plate like friction plates 17, and so on. However, the friction plates 17 are not shown in FIGS. 1 and 2. Although here one or a plurality of friction plates 17 are provided to the two filing mechanisms 3 in common, it would also be acceptable to provide them to the filing mechanisms 3 separately.

The base plate 4 is made from a plate of steel or stainless steel which is, for example, about 1.2 mm thick, and which is fixed to the inner surface of the rear cover 2c by rivets 4a, adhesive, or screws. The first and second rod members 5, 6 are solid members made from a hard engineering plastic material (for example POM), but it would also be acceptable for them to be made from a metallic material or from FRP (fiber reinforced plastic).

The first and second rod members 5, 6 extend vertically upward with respect to the base member 4 and mutually parallel to one another, from one end portions thereof that are respectively fixed at a first location 4b on the base plate 4 and at a second location 4c that is spaced away from the first location 4b toward the side cover 2b by a predetermined gap (for example 7 to 10 mm). These one end portions of the first and second rod members 5, 6 are fixed to the base plate 4 by respective vertical screws 5a, 6a.

In other words, from its first one end portion that is fixed to the first location 4b of the base plate 4, the first rod member 5 extends vertically upward with respect to the base plate 4. And, from its second end portion that is fixed to the second location 4c which is spaced along the base plate 4 away from the first location 4b toward the side cover 2b, the second rod member 6 extends vertically upward with respect to the base plate 4.

The first and second rod members 5, 6 are formed to be of equal length (for example, 50 mm), and their cross sectional shapes are, for example, square. The lengths of the first and second rod members 5, 6 are not limited to 50 mm; they could be set to be of any desired lengths in the range 20 mm through 100 mm.

The dimensions of the cross section of the first rod member 5 may, for example, be 6 mm×6 mm, and the dimensions of the cross section of the second rod member 6 may, for example, be 5 mm×5 mm, but these dimensions are not to be considered as being limitative; the cross sectional dimensions of the first and second rod members 5, 6 may be set to correspond to the lengths of the first and second rod members 5, 6.

It would also be acceptable to arrange for the cross-sectional dimensions of the first and second rod members 5, 6 to be the same. In the figures the side surfaces of the first rod member 5 are shown as being parallel to the front-rear direction and to the left-right direction. And, although the side surfaces of the second rod member 6 are shown as being inclined at 45° to the front-rear direction and to the left-right direction, it would also be acceptable for them to be parallel to the front-rear direction and to the left-right direction, just as in the case of the first rod member 5. It should also be noted that the cross sectional shapes of the first and second rod members 5, 6 may be formed in various shapes other than squares (such as rectangles, circles, polygons or the like); and these members may also be formed, not as solid members, but as hollow members.

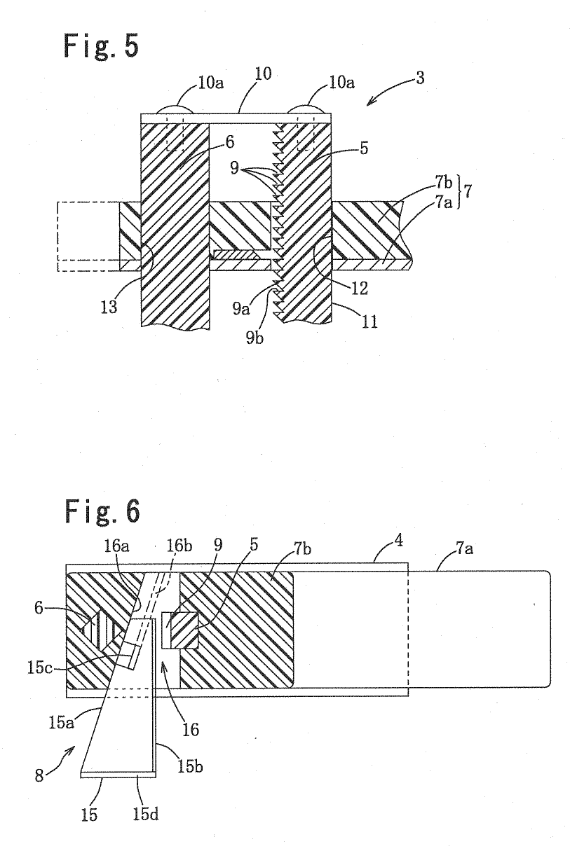

As shown in FIGS. 4 and 5, a plurality of horizontal engagement grooves 9 are formed on the entire left side surface of the first rod member 5 at a predetermined pitch (for example, 2 mm) in the vertical direction, extending orthogonally to the longitudinal direction of the first rod member and moreover being oriented in the front-rear direction. Each of these engagement grooves 9 is a letter V shaped groove having a horizontal surface 9b and an inclined surface 9a, and the inclined surface 9a slopes upward toward the left. The function of these grooves 9 will be described later.

Moreover, although this feature is not shown in FIG. 1, the other ends of the first and second rod members 5, 6 (i.e. their upper ends) are linked together by a linking member 10 consisting of a plate that is made from metal. This linking member 10 is attached to the upper ends of the first and second rod members 5, 6 by screws 10a.

Planar receiving surfaces 11 that are capable of receiving and stopping the left edge portions of document S are formed on the side surface portions (the right side surface portions) of the first rod members 5, on the opposite sides thereof to the side cover 2b.

The pressure plate 7 is for pressing the document S against the base plate 4. The pressure plate 7 has first and second guide holes 12, 13 through which the first and second rod members 5, 6 are respectively passed, and is built so as to be capable of shifting while remaining parallel to itself so as to approach toward and to recede from the base plate 4, while maintaining an attitude substantially orthogonal to the first and second rod members 5, 6. The expression “an attitude substantially orthogonal” is intended to cover, not only precise orthogonality, but also an attitude that is almost orthogonal at an angle of approximately 90°. The pressure plate 7 comprises a long and narrow pressure plate main body 7a that extends in the left-right direction and is made from metal (for example, stainless steel), and a plate shaped block member 7b that is made from synthetic resin (however, it would also be acceptable for it to be made from metal) that is fixed to the surface of a portion of the pressure plate main body 7a (at its left side portion). The pressure plate main body 7a may be made from spring steel plate.

For the pressure plate main body 7a, the length may for example be 85 to 100 mm, the width may for example be 20 to 30 mm, and the thickness may for example be 1.2 mm. However, these numerical values should not be considered as being limitative.

As shown in FIG. 4, the pressure plate main body 7a comprises a horizontal base end portion 7c, an inclined portion 7d that slopes gently downward to the right, and a horizontal tip portion 7e at its end, and is formed so as to be capable of elastically pressing on the document S. However, it would also be acceptable for the pressure plate main body 7a to be formed in the shape of a flat plate that extends horizontally in the left-right direction.

Non-slip tape 14 is adhered to the lower surfaces of the inclined portion 7d and of the tip portion 7e. It is also desirable to adhere non-slip tape to the upper surface of the base plate 4 and to the neighborhood thereof.

The thickness of the plate shaped block member 7b is, for example, 4 to 6 mm, and the plate shaped block member 7b is fixed to the upper surface of the pressure plate main body 7a by a plurality of screws, or with adhesive. Each of the first and second guide holes 12, 13 through which the first and second rod members 5, 6 are respectively passed has a vertical dimension of around 5 to 7 mm, and they are formed so that the first and second rod members 5, 6 pass through them while maintaining substantially orthogonal relationship with the pressure plate 7. In other words, only minute gaps remain between the outsides of the first and second rod members 5, 6 and the first and second guide holes 12, 13.

As shown in FIGS. 4 through 8, the locking mechanism 8 is a mechanism that is capable of locking the pressure plate 7 with respect to at least one of the first and second rod members 5, 6 in a state in which the pressure plate 7 is pressing on the document S and at any desired position along the longitudinal directions of the first and second rod members 5, 6, so that the pressure plate 7 cannot shift in the direction opposite to the direction in which it is exerting pressure (i.e. so that it cannot shift in the upward direction). In other words, the locking mechanism 8 is a mechanism that is capable of locking the pressure plate 7 in a state in which it is pressing on the document S, at any desired position along the longitudinal directions of the first and second rod members 5, 6, so that the pressure plate 7 cannot shift in the direction away from the base plate 4.

The locking mechanism 8 comprises: a plurality of engagement grooves 9 that are formed on the side surface of at least one of the first and second rod members 5, 6 (in this embodiment, on the left side surface of the first rod member 5) at a predetermined pitch in the longitudinal direction of the rod member 5, and which extend orthogonally to that longitudinal direction and are oriented horizontally in the front-rear direction; an actuation member 15 that is installed to the pressure plate 7 so as to be changeable over between a locking position, in which it engages with one of the engagement grooves 9 in the neighborhood of the pressure plate 7 (i.e. one of the engagement grooves 9 near the upper surface of the pressure plate main body 7a) and thereby locks the pressure plate 7, and a release position in which it releases that locking; and a guide portion 16 that is formed on the pressure plate 7 so as to guide this actuation member 15. This locking mechanism 8 includes a wedge mechanism that will be described hereinafter.

The guide portion 16 is formed in a flat trapezoidal cavity that extends horizontally between the pressure plate main body 7a and the plate shaped block member 7b, more to the left side than the right half portion of the first rod member 5 and more to the right side than the second rod member 6. The guide portion 16 includes a shallow groove recessed from below in the lower end portion of the plate shaped block member 7b. The guide portion 16 includes an inclined guide surface 16a that is formed to be parallel to a direction that intersects the engagement grooves 9 at an acute angle. This inclined guide surface 16a is angled, for example, by about 20° with respect to the front-rear direction.

The actuation member 15 has a guided portion 15a that is guided by the inclined guide surface 16a, and an engagement blade 15e that is formed to be parallel with the engagement grooves 9 and that is capable of engaging into an engagement groove 9 from a direction that intersects with the engagement groove 9 at an acute angle. The actuation member 15 is formed in a trapezoidal shape using a metallic plate material, and this actuation member 15 includes the guided portion 15a, a right side 15b that extends in the front-rear direction, a cut out and bent up flap 15c that is cut out and bent upward, and an actuation portion 15d at its front end portion that is formed in an upwardly curved shape.

The cut out and bent up flap 15c is engaged into an inclined groove 16b that is recessed upwards from the guide portion 16, and the guided portion 15a is kept in a state of being contacted against the inclined guide surface 16a, whereby the actuation member 15 is guided so as to shift in the front-rear direction in parallel with the inclined guide surface 16a. And the right side 15b of the actuation member 15 is chamfered, so that the engagement blade 15e that is formed on a portion of the right side 15b (refer to FIG. 8) is engaged closely with one of the engagement grooves 9.

In the state shown in FIGS. 5 and 6, the actuation member 15 is in its release position in which it is shifted forward to the maximum extent and the engagement blade 15e is withdrawn away from the engagement grooves 9 so that the pressure plate 7 is in a released state in which its locked state is released, and so that the pressure plate 7 can be shifted in the longitudinal direction of the first and second rod members 5, 6 (i.e. in the vertical direction).

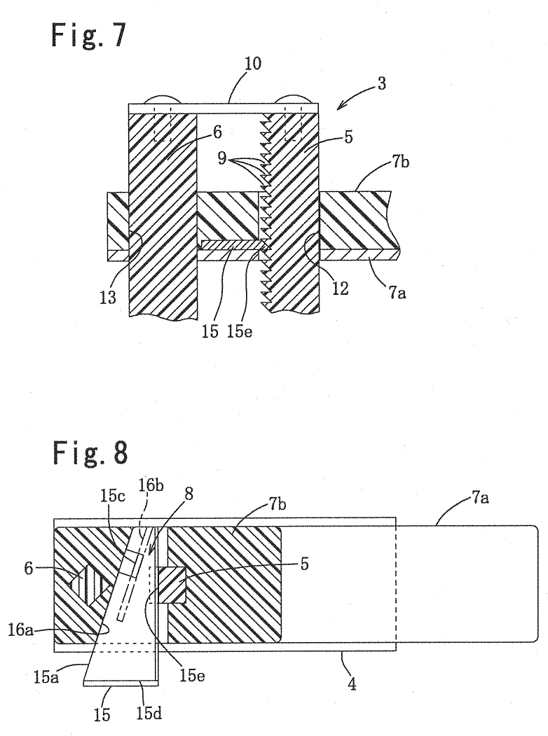

Next, in order to file document S, while pressing the pressure plate 7 strongly downward with one or both hands, the actuation member 15 is shifted rearward to the state shown in FIGS. 7 and 8. When this is done, the actuation member 15 is shifted rearward to the maximum extent and the engagement blade 15e strongly engages into one of the engagement grooves 9 by wedging operation, so that the pressure plate 7 is put into its locked position in which it is locked so that it cannot shift in the vertical direction. In the pressed state, the pressure plate 7 is elastically deformed, and thus exerts an elastic force to press on the document S. Moreover, it would also be possible to form the left edge portion of the pressure plate 7 somewhat longer as shown by the broken line in FIG. 5, in order to make it easier for the operator to exert finger pressure when pressing the pressure plate 7.

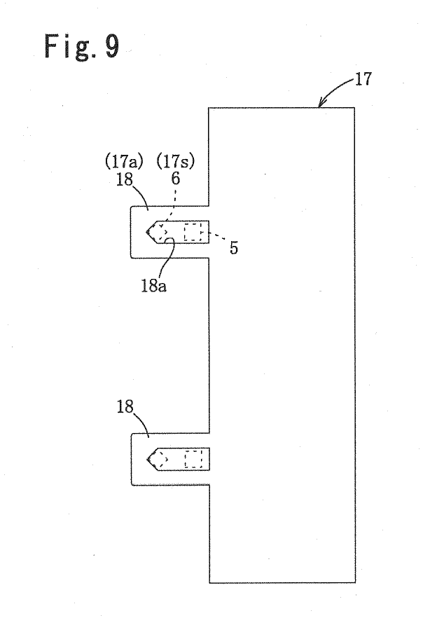

As shown in FIG. 9, two support members 17s that are fixed to the rear cover 2c or to the base plate 4 and one or a plurality of friction plates 17 each of which is provided with engagement portions 17a that can be engaged to the support members 17s at their end portions toward the side cover 2b are provided to this filing mechanism 3. One or a plurality of the friction plates 17 can be clamped between document S in a state in which the engagement portion 17a is linked to the support member 17s, and, when the file 1 is put into a vertical attitude and the cover member 2 is supported by hand with the side cover 2b upward so that the documents S are held in a hanging state in a vertical attitude, at least a portion of the frictional force for holding the documents S so that they do not fall down can thus be generated. In this embodiment, the second rod member 6 corresponds to the “support member 17s”. The two filing mechanisms 3 are provided with in common one or a plurality of the friction plates 17 described above.

As shown in FIG. 9, the friction plates 17 are thin plates of thickness about 1 mm that are made from synthetic resin or cardboard, and they are formed on both sides with frictional surfaces that are not smooth (i.e. with rough surfaces).

A pair of ear portions 18 are formed at the left edge portions of these friction plates 17 and serve as the engagement portions 17a corresponding to the pair of first and second rod members 5, 6, and an engagement hole 18a is formed in each of these ear portions 18, through which the first and second rod members 5, 6 can be passed. The friction plates 17 are formed to have such a shape and such a size as to include the region where the pressing force from the pressure plate 7 acts. Moreover, the front to rear length of the friction plates 17 in FIG. 9 is the same as the front to rear length of the A4 size, while the horizontal width of the friction plates 17 is about ⅓ of the horizontal width of the A4 size. It should be understood that it would also be acceptable to arrange for the friction plates 17 to be made from thin plate in which a large number of small holes are formed, or from thin plate in the form of a mesh.

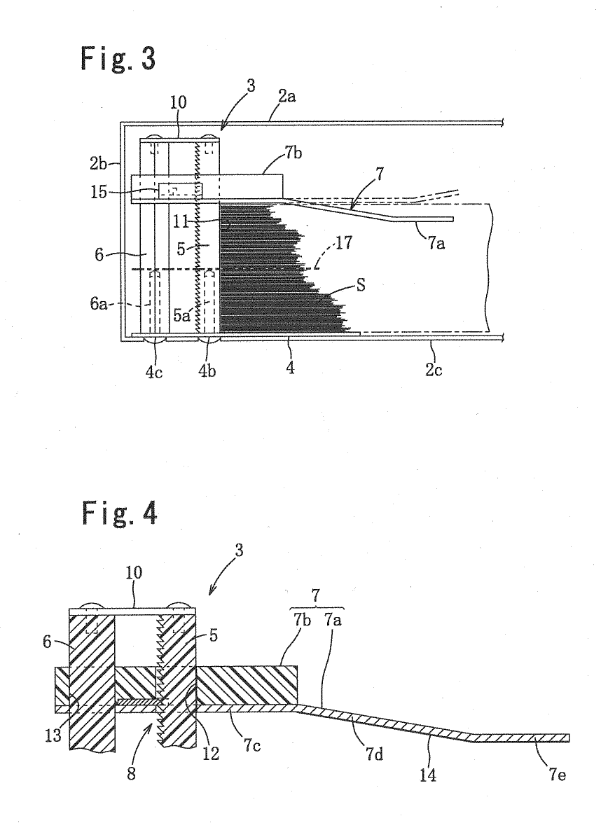

As shown in FIG. 3, in the state in which the pair of first and second rod members 5, 6 are inserted through the pair of engagement holes 18a, the friction plates 17 are clamped in a state of being pressed between the document S. When this has been done, if the file 1 in which the document S are filed is held by hand with the side cover 2b positioned upward so that the document S hang downward vertically, the document S will be held securely by the frictional force acting from the pressure plate 7, the frictional force acting from the base plate 4, and the frictional forces acting from both sides of the friction plates 17.

The frictional force at each section is a force that is determined by the pressing force acting on the document S and the respective frictional coefficient, but if it is supposed that the frictional coefficient is constant, then, since a common pressing force acts on each section, accordingly the frictional force that holds the document S is approximately doubled by providing one friction plate 17. Moreover, if two friction plates 17 are provided at different locations in the thickness direction, then the frictional force holding the document S will be multiplied by three, and, if three friction plates 17 are provided at different locations in the thickness direction, then the frictional force holding the document S will be multiplied by four.

In this way, by utilizing the friction plates 17, it is possible greatly to increase the frictional force when the document S are held in a vertical attitude, and if there is a margin of extra frictional force, then it is possible to reduce the force for pressing on the document S with the pressure plate 7.

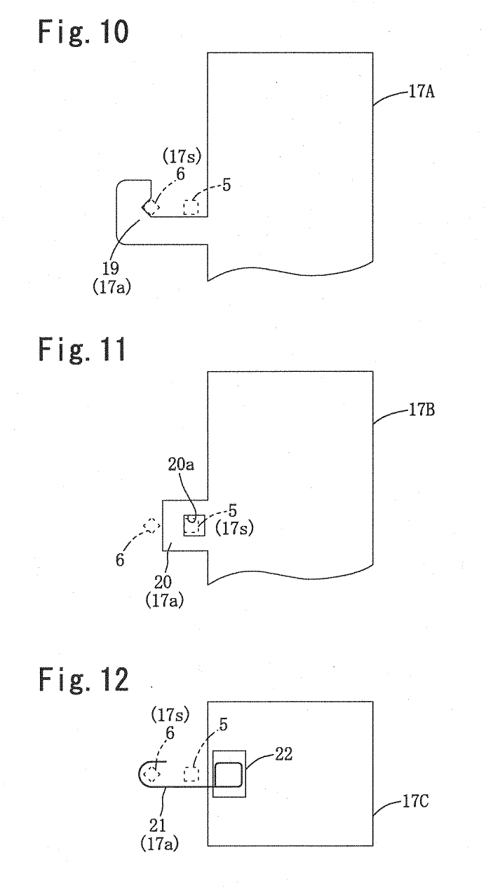

The shape of the engagement portion 17a of the friction plate 17 is not limited to the shape shown in FIG. 9; it would also be acceptable to form the friction plate in one of the shapes shown in FIG. 10 through FIG. 12. An engagement portion 17a of a friction plate 17A of a first variant shown in FIG. 10 consists of an engagement hook 19 that is engaged to the second rod member 6 (i.e. support member 17s). And the engagement portion 17a of a friction plate 17B of a second variant embodiment shown in FIG. 11 consists of an ear member 20 in which a through hole 20a is formed through which the first rod member 5 (which here corresponds to the support member 17s) is passed. Moreover, the friction plate 17C of a third variant shown in FIG. 12 is formed as a small rectangular plate that includes a pressure region on which one of the pressure plate 7 presses. Its engagement portion 17a consists of a wire that is fixed to the friction plate 17C with a tape 22, and that is formed into a hook portion 21 that can be engaged with the second rod member 6.

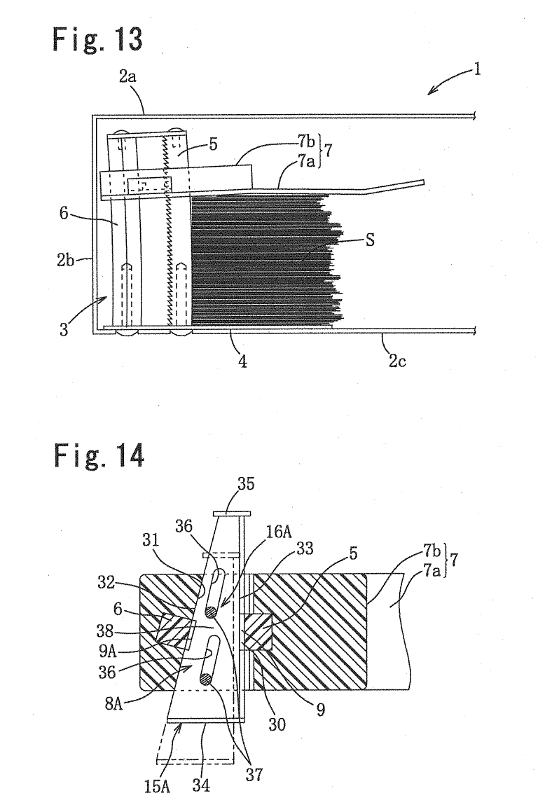

As shown in FIG. 13, in a state in which the documents S have been filed by being strongly pressed by the pressure plate 7, the first and second rod members 5, 6 are elastically deformed into gentle curves within the plane that includes the first and second rod members 5, 6 by the bending moment acting from the pressure plate 7, so that elastic force acting in the direction of pressing acts on the documents S. However, the above described elastic deformation of the first and second rod members 5, 6 is not essential.

The operation and the advantages of the file 1 and the filing mechanisms 3 explained above will now be further explained.

With this file 1 and file mechanism 3, it is possible to perform filing reliably with a simple pressing operation, without opening any punched holes in the document S. Due to this, it is possible considerably to shorten the time required for the task of filing document S. Moreover, when extracting some document S that have been filed, it is possible to extract only the desired document S with a simple operation. And furthermore, when a document S that has been filed is to be read, it is possible to retrieve the document S from the file and to read it as required.

Since, due to the wedge mechanism in the locking mechanism 8 that includes the guide portion 16 and the actuation member 15, it is possible to engage the engagement blade 15e of the actuation member 15 into one of the engagement grooves 9 on the side surface of the rod member with a strong force, accordingly pressure plate 7 does not wobble with respect to the rod member 5, and it is possible to prevent reduction of the pressure for pressing on the document S. The wedge mechanism that includes the guide portion 16 and the actuation member 15 is advantageous in ensuring the vertical thickness of documents that can be filed, because the thickness dimension of the wedge mechanism is small.

The first and second rod members 5, 6 are erected vertically on the base plate 4 with a gap being left between them in the left-right direction, and, since the first and second rod members 5, 6 are inserted through the first and second guide holes 12, 13 in the pressure plate 7 which are of certain predetermined vertical lengths with almost no remaining gap, so that it is thereby arranged for the pressure plate 7 to be capable of approaching toward the base plate 4 and of moving away therefrom, accordingly it is possible to maintain the state in which the pressure plate 7 is almost orthogonal with respect to the first and second rod members 5, 6. Due to the first and second rod members 5, 6, the rigidity and the strength of the construction that pressurizes the document S with the pressure plate 7 are increased, and the performance for guiding the pressure plate 7 so that it shifts while remaining parallel with itself is increased, so that accordingly it is possible to increase remarkably the filing performance for pressing on the document S with the pressure plate 7. Moreover, there is no unreasonableness in the design of the file 1, and unbalance in the external appearance and design of the file 1 is also resolved.

Since the friction plate 17 which is connected to at least one of the first and second rod members 5, 6 is provided in the state of being sandwiched between the document S, and, in the filed state, the document S are also pressed against the friction plate 17, and since, when the document S that have been filed are held in a hanging state in the vertical attitude, at least a part of the frictional force that holds the document S is also generated between the two sides of the friction plate 17 and the document S, accordingly it is possible to strengthen the frictional force that holds the document S by doubling it (or by trebling it or even more) in a simple manner.

Since, in the state in which the document S are strongly filed, the first and second rod members 5, 6 are elastically deformed into gently curved shapes within the plane that includes the first and second rod members 5, 6, and since a pressing force operates to press on the document S elastically via the pressure plate 7 from the first and second rod members 5, 6 that are thus elastically deformed, accordingly a stabilized pressing action can be obtained.

Since, in the locking mechanism 8, the angle between the engagement grooves 9 and the inclined guide surface 16a is about 20°, and since the wedge mechanism that engages the engagement blade 15e into one of the engagement grooves 9 by guiding the actuation member 15 with the inclined guide surface 16a while the actuation member 15 is advanced rearward is provided, accordingly it is possible to engage the engagement blade 15e strongly with one of the engagement grooves 9. Since, at this time, the engagement blade 15e shifts along the inclined surface 9a of the engagement groove 9 downward slightly with respect to the engagement groove 9, accordingly this is advantageous from the point of view of strengthening the pressing force.

When the file 1 according to this embodiment was prototyped and tested, it was found that it was possible to file document S having a thickness of about 50 mm. In particular, when two of the friction plates 17 were sandwiched in different locations between the document S, it was found that this file 1 was sufficiently effective in practice, since the state of filing of the document S was maintained perfectly even when, in the state in which the document S were hanging downward vertically from the filing mechanisms 3, the filing mechanisms 3 and the document S were shaken up and down at a relatively high speed.

Next, a plurality of variant examples in which the above embodiment is partially changed will be explained.

### Variant Example #1 (Refer to FIG. 14)

Instead of the locking mechanism 8 described above, a locking mechanism 8A may be employed. This locking mechanism 8A comprises a plurality of engagement grooves 9 that are formed on the left side portion of the first rod member 5, a plurality of engagement grooves 9A that are formed on the right side portion of the second rod member 6, an actuation member 15A, and a guide portion 16A. The pluralities of engagement grooves 9, 9A are similar. The actuation member 15A is installed in the guide portion 16A which is shiftable in parallel with the pressure plate 7, and has an engagement blade 30 that is formed to be parallel with the engagement grooves 9 and that moreover is capable of engaging with the engagement grooves 9 in the neighborhood of the pressure plate 7 from a direction that intersects the engagement grooves 9 at an acute angle.

The guide portion 16A that is formed on the pressure plate 7 has an inclined guide surface 31 that guides the actuation member 15A so that the actuation member 15A shifts in a direction parallel to a direction that intersects at an acute angle with the engagement grooves 9 in the neighborhood of the pressure plate 7. The actuation member 15A is formed as a trapezoidal plate that is elongated in the front-rear direction, and has a guided portion 32 formed on its left edge portion that is guided by the inclined guide surface 31 in a sloping manner, a chamfered portion 33 formed on its right edge portion, an actuation section 34 formed at its front end portion, and a rear edge actuation section 35 formed at its rear end portion. The angle between the guided portion 32 and the chamfered portion 33 is around 15°. And the guide portion 16A comprises a pair of front-rear slits 36 that extend parallel with the guided portion 32, and a pair of pins 37 that are fixed to the pressure plate 7 and each of which is inserted into one of the pair of slits 36.

In FIG. 14, the actuation member 15A is in its locking position, and, when this actuation member 15A is to be changed over to its release position, the actuation section 34 or the rear edge actuation section 35 is shifted forward in a direction parallel to the inclined guide surface 31, so that the engagement blade 30 is removed from the engagement groove 9. Since a continuous wall portion 38 is present between the pair of slits 36, accordingly it is possible for force to be reliably transmitted from the angled guide surface 31 to the engagement blade 30.

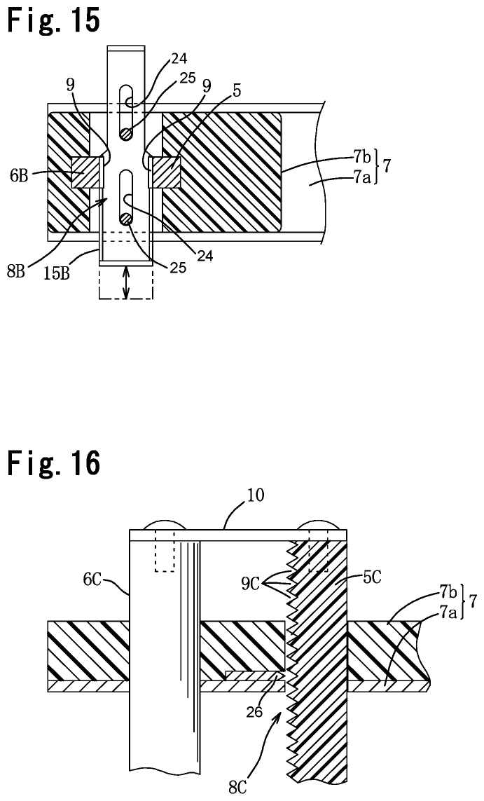

### Variant Example #2 (Refer to FIG. 15)

In the locking mechanism 8B, the second rod member 6B is disposed in a state of not being inclined with respect to the first rod member 5, a plurality of engagement grooves 9 are formed on each of the left side surface of the first rod member 5 and on the right side surface of the second rod member 6B, engagement blades are formed on both left and right edges of the actuation member 15B, and the actuation member 15B is guided so as to shift forward and backward by a pair of slits 34 and a pair of pins 35. Actuation sections are formed on both the front and rear end portions of the actuation member 15B.

### Variant Example #3 (Refer to FIG. 16)

In the locking mechanism 8C, a plurality of engagement grooves 9C whose cross sections are shaped as triangular are formed on the left side surface of the first rod member 5C, and the cross sectional shape of the engagement blade 36 is also the same as that of the engagement grooves 9C. The second rod member 6C may be formed as a pillar whose cross section is circular.

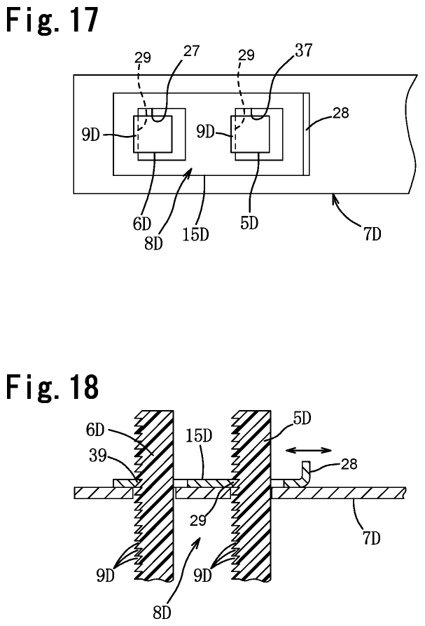

### Variant Example #4 (Refer to FIGS. 17 and 18)

In the locking mechanism 8D, the first and second rod members 5D, 6D are both square cross section members, and a plurality of engagement grooves 9D are formed on the left side surfaces of both the first and second rod members 5D, 6D. Each of the engagement grooves 9D is formed with a horizontal surface and an inclined surface, and the inclined surface is formed so as to slope downward to the left. The pressure plate 7D is built with a pressure plate main body that is made from a magnetic material, and the plate shaped block member 7b made from synthetic resin material is omitted. And the actuation member 15D is made so as to be attracted to the pressure plate 7D by magnetism.

Two openings 37 and an actuation section 38 are formed are formed in the actuation member 15D for passing the first and second rod members 5D, 6D, and an engagement blade 39 is formed on the left edge portion of each of the openings 37.

When the actuation member 15D is shifted to the right from the state in which the pressure plate 7D is pressed without the engagement blades 39 being engaged in the engagement grooves 9D, each of the engagement blades 39 engages into one of the engagement grooves 9D, so that it is possible to lock the pressure plate 7D in the horizontal state in which it cannot shift up or down. The function of the actuation member 15D being attracted by magnetism is not essential.

Moreover, the first and second rod members 5D, 6D may be made from circular cylindrical metal material or pipe material, and the lower end portions of the first and second rod members 5D, 6D may be fixed to the base plate 4 by welding or adhesion; and, if a pipe material is employed, then it would also be possible to fix the lower end portions of the first and second rod members 5D, 6D to the base plate 4 by riveting.

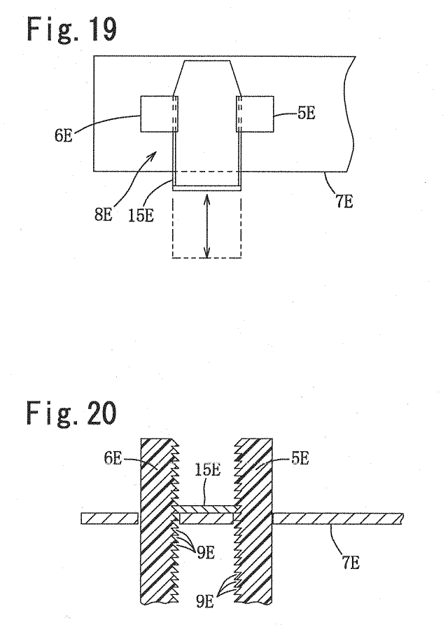

### Variant Example #5 (Refer to FIGS. 19 and 20)

In the locking mechanism 8E, the pressure plate 7E is built with a pressure plate main body, and the plate shaped block member 7b made from synthetic resin material is omitted. A plurality of engagement grooves 9E are formed on the left side surface of the first rod member 5E, and a plurality of engagement grooves 9E are formed on the right side surface of the second rod member 6E.

Each of the engagement grooves 9E on the first rod member 5E is formed with a horizontal surface and an inclined surface, and the inclined surfaces are formed so as to slope downward to the left. Moreover, each of the engagement grooves 9E on the second rod member 6E is formed with a horizontal surface and an inclined surface, and the inclined surfaces are formed so as to slope downward to the right. The actuation member 15E is made so as to be capable of being attracted to the pressure plate 7E by magnetism, and when, in the state in which the pressure plate 7E is pressed, the actuation member 15E is engaged to engagement grooves 9E on the left and right sides as shown by the solid lines, the pressure plate 7E can be locked in an almost horizontal state. The function of the actuation member 15E being attracted by magnetism is not essential.

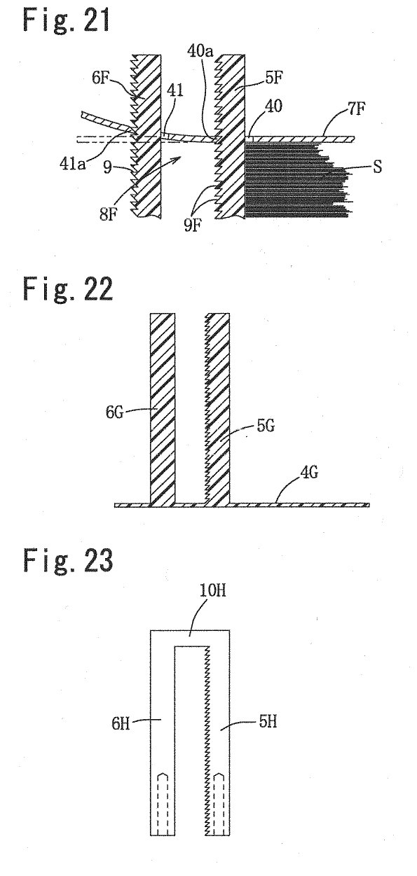

### Variant Example #6 (Refer to FIG. 21)

A plurality of engagement grooves 9F that are similar to the engagement grooves 9E described above are formed on the left side of the first rod member 5F, and engagement grooves 9 that are similar to the engagement grooves 9 described above are formed on the left side of the second rod member 6F.

With this locking mechanism 8F, the actuation member is omitted, and the pressure plate 7F is built with a pressure plate main body that can be elastically deformed, with the plate shaped block member of the pressure plate also being omitted. An engagement blade 40a is formed on the left edge portion of the first guide hole 40 through which the first rod member 5F passes, and engages with the engagement grooves 9F; and an engagement blade 41a is formed on the left edge portion of the second guide hole 41 through which the second rod member 6F passes, and engages with the engagement grooves 9.

The first and second rod members 5F, 6F are built so as to be capable of being elastically deformed in the left-right direction, and, in the state in which the documents S are being pressed with the pressure plate 7F and the engagement blade 40a is engaged into one of the engagement grooves 9F as seen in the figure, the pressing state shown in the figure is established when by pushing up the left end portion of the pressure plate 7F, due to elastic deformation thereof, the engagement blade 41a engages into one of the engagement grooves 9. And, when this pressing state is to be released, the second rod member 6F is elastically deformed toward the right, so that the engagement of the engagement blade 41a is released from the engagement groove 9, and then the engagement of the engagement blade 40a from the engagement groove 9F is released. The linking member that connects together the upper end portions of the first and second rod members 5F, 6F is omitted.

### Variant Example #7 (Refer to FIG. 22)

The first and second rod members 5G, 6G and the base plate 4G may also be formed integrally by a molding process, employing a synthetic resin material or a metallic material (aluminum alloy or magnesium alloy). If a synthetic resin material is used, then it would also be acceptable to install a reinforcing base plate made from metal by insertion molding.

### Variant Example #8 (Refer to FIG. 23)

It would also be acceptable to form the first and second rod members 5H, 6H and a linking member 10H that connects their upper ends together integrally by a molding process, employing a synthetic resin material or a metallic material (aluminum alloy or magnesium alloy).

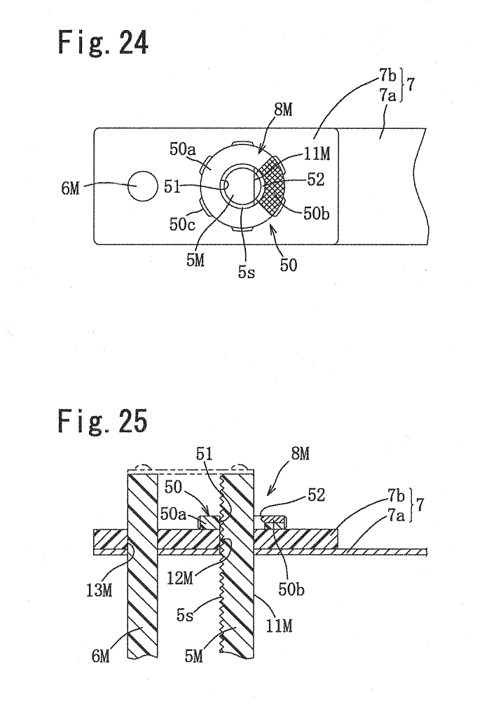

### Variant Example #9 (Refer to FIGS. 24 Through 26)

Instead of the locking mechanism 8 described above, it would also be possible to employ the locking mechanism 8M shown in FIGS. 24 and 25. The first rod member 5M is built as a cylindrical rod member with its right side portion (its portion that corresponds to around ⅓ of its circumference) being cut away to form a planar receiving surface 11M that is capable of receiving and stopping the left edge portion of a document S on the right side surface of the first rod member 5M, and with a screw portion 5s of discontinuous helical form (i.e. a portion of a right-handed screw) including a plurality of thread portions being formed on the remaining partial cylindrical external peripheral surface of the portion of the first rod member 5M other than its right side portion (i.e. its portion corresponding to around ⅔ of its circumference). Thus, the first rod member 5M has an outer peripheral surface that includes the receiving surface 11M and the part cylindrical surface (i.e. the screw portion 5s).

A guide hole 12M through which the first rod member 5M passes with a minute gap being left therebetween and a guide hole 13M through which the second rod member 6M passes with a minute gap being left therebetween are formed in the pressure plate 7, and thus the pressure plate 7 is capable of shifting upward and downward while maintaining a substantially orthogonal relationship with respect to the first and second rod member 5M, 6M. The first and second rod members 5M, 6M are made from a synthetic resin material or from a metallic material.

While the actuation member 50 may be made from a metallic material, the greater portion of the actuation member 50 of this variant embodiment is made from a synthetic resin material (for example, from POM), and the actuation member 50 is disposed above a plate shaped block member 7b of the pressure plate 7. A through hole 51 through which the first rod member 5M is passed is formed in the center portion of the actuation member 50, and one or a plurality of circular arcuate engagement teeth 52 that are capable of engagement with the screw portion 5s of the first rod member 5M are formed on a portion of the internal circumferential portion of the through hole 51 (on about ¼ of that circumferential portion).

In the actuation member 50, a circular arcuate portion 50b that includes the portion on which the one or a plurality of engagement teeth 52 are formed and having about ⅓ of the total thickness is formed from a metallic plate, and this circular arcuate portion 50b is fixed to the main body portion 50a other than the arcuate portion 50b that is made from synthetic resin by adhesive or by a screw. It would also be acceptable, for example, to form a patterned or colored portion on the upper surface of the circular arcuate portion 50b, in order to indicate the position of the engagement tooth or teeth 52. A plurality of convex portions 50c are formed on the external circumferential portion of the actuation member 50, in order to prevent slippage.

In a state in which the actuation member 50 is rotated so that the engagement tooth or teeth 52 are opposing the receiving surface 11M, since the engagement teeth 52 are not engaged with the screw portion 5s, accordingly the actuation member 50 is in the locking released position, and the pressure plate 7 is in the locking released state and can be shifted upward and downward, so that it is possible to attach and release the document S. When document S is to be filed, after having pressed the document S downward with the pressure plate 7 and the actuation member 50 in the state described above with a strong pressing force, the actuation member 50 is then rotated through about 90° in the rightward screwing direction, and the engagement tooth or teeth 52 engage with the screw portion 5s and the actuation member 50 is put into its locking position.

When, from this engaged state, the actuation member 50 is further rotated in the rightward screwing direction through about 180°, it is shifted along the screw portion 5s while the engagement tooth or teeth 52 remain engaged with the screw portion 5s, and thereby the actuation member 50 and the pressure plate 7 are shifted downward slightly and the pressure for pressing on the document S is strengthened, and the actuation member 50 maintains its locking position.

The engagement tooth or teeth 52 are inclined so as to match the lead angle of the screw portion 5s. It is desirable to form the end portions of the threads or the end portions of the engagement teeth 52 in a tapered shape, in order to avoid collision between the engagement teeth 52 and the end portions of the threads of the screw portion 5s.

Furthermore, in the pressure plate 7, the plate shaped block member 7b may be omitted, and the actuation member 50 which has a thickness similar to the thickness of the plate shaped block member 7b may be installed on the upper surface of the pressure plate 7 which consists of a pressure plate main body, so as to be rotatable while not having any play. If this construction is adopted, it is possible to obtain the guidance function of the first guide hole 12M in the plate shaped block member 7 via the through hole 51 in the actuation member 50.

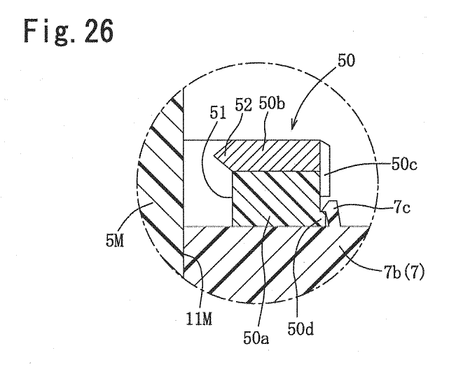

According to requirements, as shown in FIG. 26, a flange portion 50d may be formed on the lower end portion of the actuation member 50 all around its circumference, and a plurality of engagement latches 7c may be formed on the upper surface portion of the pressure plate 7, so as to engage with and hold down the flange portion 50d.

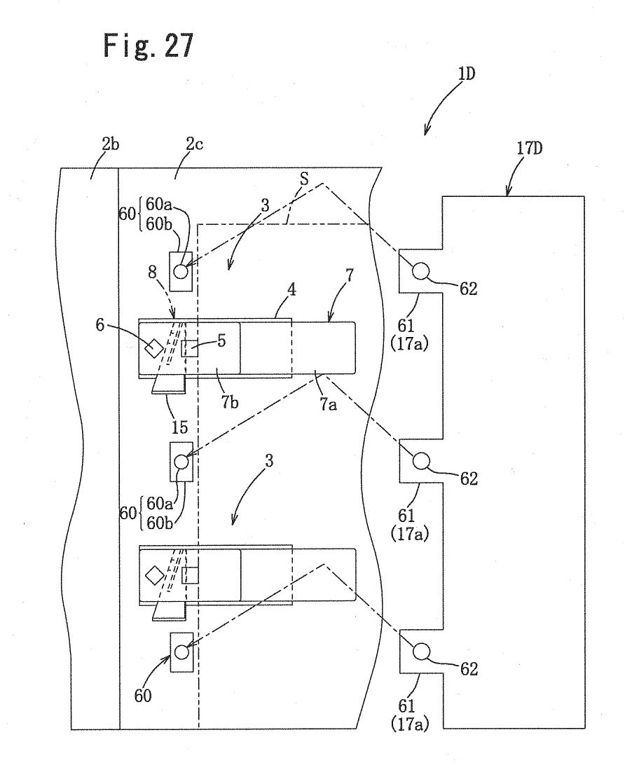

### Variant Example #10 (Refer to FIG. 27)

In this file 1D, three support members 60 that hold a friction plate 17D are fixed at the front portion, at the central portion, and at the rear portion of the left edge portion of the inner surface of the rear cover 2c. However it would also be acceptable, instead of providing three support members 60, only to provide two support members 60.

Each of the support members 60 comprises a base portion 60b that is rectangular in shape and of thickness 2 to 3 mm and a cylindrical rod-shaped rod portion 60a that is integrally erected from the central portion of the base portion 60b, and the support member 60 is made integrally from a hard synthetic resin material (for example, POM). The external diameter of the rod portion 60a may, for example, be 4 to 6 mm, and its length may be almost equal to the length of the first and second rod members 5, 6, or may be somewhat shorter. The base portion 60b is fixed by adhesive or a screw to the inner surface of the rear cover 2c.

For example, two friction plates 17D may be used as friction plates that are linked to the support members 60 described above. Each of the friction plates 17D is made from a thin plate material, similar to that of the friction plates 17 described above. As engagement portions 17a corresponding to the three support members 60, three ear portions 61 are formed at the left edge portion of each of the friction plates 17D so as to project leftward, and an engagement hole 62 having diameter somewhat larger than the rod portions 60a is formed in each of the ear portions 61.

Each of the friction plates 17D can be sandwiched between the document S in a state in which the three engagement portions 17a are linked to the three rod portions 60a by each of the rod portions 60a being engaged into its corresponding engagement hole 62, and when, in this state in which the friction plates are sandwiched between the document S, the document S are put into a vertical attitude and kept in the hanging state, at least a part of the frictional force for holding the document S so that they do not fall down can be generated. According to the structure described above, it is possible to detach the friction plates 17D without any involvement of the first and second rod members 5, 6.

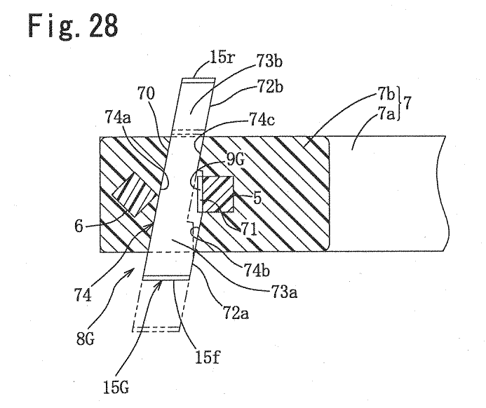

### Variant Example #11 (Refer to FIG. 28)

The locking mechanism 8G comprises a plurality of engagement grooves 9G that are formed on the left side surface of the first rod member 5 at a predetermined pitch in the longitudinal direction of the first rod member 5 and moreover orthogonally to the longitudinal direction (these are similar to the engagement grooves 9 described above), and an actuation member 15G that is installed to the pressure plate 7 and that can be changed over to a locking position in which it locks the pressure plate 7 by engaging into one of the engagement grooves 9 in the neighborhood of the pressure plate 7, and to a release position in which this locking is released. An actuation section 15f is formed at the front edge of the actuation member 15G by bending it into a vertical orientation, and another actuation section 15r is formed at the rear edge of the actuation member 15G by bending it into a vertical orientation.

The actuation member 15G is formed from a metallic plate in a shape that is close to a parallelogram, and its left edge 70 is formed in the shape of a straight line that is angled at about 80° to the left-right direction, with an engagement blade 71 that is parallel to the front-rear direction being formed at the central portion of its right edge, while the front edge portion 72a and the rear edge portion 72b of its right edge are formed to be parallel to its left edge 70 with the left to right width of the rear portion 73b of the actuation member 15G being set to be smaller than the left to right width of its front portion 73a. This actuation member 15G is installed in a guide portion 74 that is formed on the plate shaped block member 7b of the pressure plate 7, so as to be shiftable in the front to rear direction in parallel with an inclined guide surface 74a thereof.

Since the right edge of the front portion 73a is guided by the front guide surface portion 74b of the guide portion 74 and the right edge of the rear portion 73b is guided by the rear guide surface portion 74c, accordingly the actuation member 15G is guided to shift in parallel with the inclined guide surface 74a. When the actuation member 15G is shifted rearward and the engagement blade 71 is engaged to one of the engagement grooves 9G, the pressure plate 7 is put into its locked state; while, when the actuation member 15G is shifted forward and the engagement blade 71 is removed from the engagement groove 90, the pressure plate 7 is put into its locking released state.

Next, examples in which the above concrete examples are partially changed will be explained.

1) It would also be acceptable to built the first and second rod members as compound members including both a member portion made from synthetic resin and also a member portion made from metal. For example, it would be possible to provide a construction in which a plurality of engagement grooves are formed on the side surface of a pipe member made from metal, and a member made from synthetic resin is fixed thereto (by adhesion or by screws). Furthermore, the cross sectional shapes of the first and second rod members, apart from being as described above, may also be a letter I shape elongated in the left-right direction, a letter H shape widened in the left-right direction, a letter U shape, a letter V shape, a grooved shape, or the like.

2) If the first and second rod members 5, 6 are made from a metallic material, then the lower end portions of the first and second rod members 5, 6 may be joined to the base plate 4 by welding, or may be adhered by riveting or by adhesion.

Furthermore, it is also possible to enhance the strength for connecting the first and second rod members 5, 6 to the base plate 4 by joining the lower end portions of the first and second rod members 5, 6 to rod portions that are cut out and raised up from the base plate 4.

3) The shape of the engagement grooves 9 is not limited to being that shown in the above embodiments; the engagement grooves could be formed as triangular in cross section, or the engagement grooves 9 could be formed with horizontal surfaces and inclined surfaces (i.e. surfaces that slope downward to the left).

4) Apart from the locking mechanisms described in the above embodiment and variant embodiments, the locking mechanism 8 may also be a locking mechanism having some other type of structure.

5) Although an example has been explained in which two of the filing mechanisms 3 are provided to the file 1, it would also be acceptable to provide a single filing mechanism 3 to the file 1, or three or more thereof. It would also be possible to form the pair of base plates 4 for the pair of filing mechanisms 3 that are provided to the file 1 integrally with one another, or to form the pair of the pressure plates 7 integrally with one another.

6) A filing mechanism 3 that is applied to some product other than a file 1 may also be used by being fixed to the surface of a thick paper or cardboard base by adhesion or rivets or the like. In this case, it would be possible to provide only one filing mechanism 3.

7) While, in the embodiment described above, the case of provision of a file 1 for filing documents of A4 size has been explained as an example, the file 1 may be manufactured in various sizes for filing documents of various sizes.

8) Since, if the lower edge of document S that has been filed is aligned with the lower edge of the cover member 2 as shown in FIG. 1, then it is not necessary to support the weight of the document S with the cover member 2 when the file 1 is stood on a bookshelf or the like, accordingly it is possible to make the cover member 2 from cardboard or the like that is quite thin (about 1 mm thick, for example).

9) If the rear cover 2c of the cover member 2 is made as a thick and rigid plate member, then it is possible for a portion of the rear cover 2c also to serve as the base plate 4.

10) In the file 1 described above, instead of forming a receiving surface 11 for receiving and stopping the left edge of document S on the right side surface of the first rod member 5, it would also be acceptable to arrange to fix one or a plurality of rod shaped or plate shaped receiving surface definition members, which are members different from the first rod member 5, to the inner surface of the rear cover 2c, thus defining a receiving surface for receiving and stopping the left edge of the documents S at the right side surface of those receiving surface definition members. However, it is necessary for this receiving surface to be positioned at the same position as the right side surface of the first rod member 5, or at a position rightward thereof.

11) Apart from the above, as additional modifications, it would be possible for a person of ordinary skill in the art to implement various changes to the embodiment and variant examples described above without deviation from the gist of the present invention, and the present invention should be considered also to include such modifications.

### DESCRIPTION OF REFERENCE NUMERALS

S: object to be filed (document)
1: file
2: cover member
2a: front cover
2b: side cover
2c: rear cover
3: filing mechanism
4: base plate
4b, 4c: first and second location
5, 5C through 5G, 5M: first rod member
6, 6A through 6G, 6M: second rod member
5a, 6a: screw
7: pressure plate
7a: pressure plate main body
7b: plate shaped block member
8, 8A through 8F, 8G, 8M: locking mechanism
9, 9C through 9E: engagement groove
10: linking member
11, 11M: receiving and stopping surface
12, 12M: first guide hole
13, 13M: second guide hole
15, 15A, 15B, 15D, 15E, 15G: actuation member
15a: guided portion
15e, 30, 45, 71: engagement blades
16a: inclined guide surface
16, 16A, 74: guide portion
17, 17A, 17B, 17C, 17D: friction plate
17a: engagement portion
50: actuation member
51: through hole
52: engagement tooth
17s, 60: support members

1. A file for filing an object to be filed such as documents or the like, characterized by comprising:
a cover member comprising a front cover, a side cover and a rear cover;
a base plate fixed to an inner surface of said rear cover;
a first rod member that extends vertically with respect to said base plate from a first end portion that is fixed at a first location on said base plate;
a second rod member that extends vertically with respect to said base plate from a second end portion that is fixed at a second location on said base plate that is spaced by a certain gap toward said side cover from said first location;
a pressure plate for pressing the object to be filed toward said base late, having first and second guide holes through which said first and second rod members respectively pass, and shiftable parallel to itself so as to approach toward and recede from said base plate while maintaining an attitude substantially orthogonal to said first and second rod members; and
a locking mechanism that is capable of locking said pressure plate with respect to at least one of said first and second rod members at any desired position in a longitudinal direction of said first and second rod members, so that said pressure plate cannot shift in a direction to recede from said base plate.

2. The file according to claim 1, comprising a support member that is fixed to said rear cover or to said base plate, and characterized by comprising one or a plurality of friction plates, each comprising an engagement portion capable of being linked to said support member at one end portion towards said side cover, and each being capable of being sandwiched between objects to be filed in a state in which said engagement portion is linked to said support member, and capable, in said state of being sandwiched between said objects to be filed, of generating at least a portion of the frictional force that holds said filed objects when said filed objects are held in a hanging state in a vertical attitude.

3. The file according to claim 1, characterized in that said locking mechanism comprises a plurality of engagement grooves that are formed on a side surface of at least one of said first and second rod members at a predetermined pitch in a rod member longitudinal direction and orthogonally to said longitudinal direction, and
an actuation member installed to said pressure plate that can be changed over between a locking position in which it engages with said engagement groove in a neighborhood of said pressure plate and locks said pressure plate, and a release position in which said locking is released.

4. The file according to claim 1, characterized in that:
said first rod member has an outer peripheral surface including a planar receiving surface capable of receiving and stopping an edge portion of said object to be filed and a partial cylindrical surface;
said locking mechanism comprises a screw portion having a discontinuous helicoid shape including a plurality of screw threads formed on said part cylindrical surface, an actuation member installed on said pressure plate, and a through hole formed in said actuation member so as to pass said first rod member, said through hole having one or a plurality of circular arcuate engagement teeth at a part of its internal circumferential portion that are capable of engaging with said screw portion; and
in a state in which said one or a plurality of engagement teeth are opposing said receiving surface, said actuation member and said pressure plate can be shifted with respect to said first rod member along the longitudinal direction of said first rod member, and, in a state in which said engagement tooth and said screw portion are mutually engaged, said actuation member and said pressure plate are locked with respect to said first rod member, so as not to be able to shift in the direction away from said base plate.

5. The file according to claim 1, characterized in that a receiving surface that is capable of receiving and stopping an edge portion of the object to be filed is formed on a side surface portion of said first rod member on an opposite side thereof to said side cover.

6. The file according to claim 1, characterized in that said pressure plate comprises a pressure plate main body made from metal and a plate shaped block member made from synthetic resin or from metal that is fixed to a surface of a portion of the said pressure plate main body, with said first and second guide holes being formed so that said first and second rod members respectively pass through said first and second guide holes while maintaining substantially orthogonal relationship with said pressure plate.

7. The file according to claim 6, characterized in that a linking member is provided that links together an other end portion of said first rod member and an other end portion of said second rod member, and said first and second rod members are built so that, in a state in which the object to be filed is pressed by said pressure plate and filed, said first and second rod members are elastically deformed within a plane that includes said first and second rod members by a bending moment that acts from said pressure plate, and thereby elastic force acts on the object to be filed in the direction of pressing.

8. The file according to claim 1, characterized in that one end portion of said first rod member and one end portion of said second rod member are fixed to said base member with screws.

9. The file according to claim 1, characterized in that said first and second rod members are formed integrally with said base member.

10. The file according to claim 3, characterized in that said locking mechanism has an inclined guide surface formed on said pressure plate parallel to a direction that intersects said engagement grooves at an acute angle, and said actuation member has a guided portion that is guided by said inclined guide surface, and an engagement blade that is formed to be parallel to said engagement grooves and is capable of engaging into said engagement grooves from a direction that intersects said engagement grooves at an acute angle.

11. A filing mechanism for filing an object to be filed such as a document or the like, characterized by comprising:
a base plate;
a first rod member that extends vertically with respect to said base plate from a first end portion that is fixed at a first location on said base plate, and formed with a receiving surface on a side surface portion for receiving and stopping an edge portion of the object to be filed;
a second rod member that extends vertically with respect to said base plate from a second end portion that is fixed at a second location on said base plate that is spaced by a certain gap from said first location in the opposite direction to said receiving surface;
a pressure plate for pressing the object to be filed toward said base member, having first and second guide holes through which said first and second rod members respectively pass, and shiftable parallel to itself so as to approach toward and recede from said base plate while maintaining an attitude substantially orthogonal to said first and second rod members; and
a locking mechanism that is capable of locking said pressure plate with respect to at least one of said first and second rod members at any desired position in the longitudinal direction of said first and second rod members, so that it cannot shift in the direction to recede from said base plate.

12. The file according to claim 1, wherein
a pair of filing mechanisms are provided on an inner surface of said rear cover of said cover member with a predetermined space between the filing mechanisms along a lengthwise direction of said rear cover of said cover member,
each of said filing mechanisms includes a respective said base member, respective said first and second rod members, respective said pressure plate and respective said locking mechanism.

13. The file according to claim 1, wherein
said pressure plate comprises a long and narrow pressure plate main body made from metal extending by a predetermined length along a breadthwise direction of said cover member, and a plate shaped block member made form synthetic resin which is fitted on a portion of said pressure plate main body on a near side to said side cover of said cover member.

14. The file according to claim 3, wherein
a plurality of said engagement grooves are formed on a side surface of said first rod member that is facing said second rod member, and
each of said engagement grooves is formed to be a V shaped groove including a horizontal surface and an inclined surface inclined upward toward said second rod member.

15. The file according to claim 3, wherein
said first and second rod members each have a square cross section,
in each of said first and second rod members, a plurality of said engagement grooves are formed on a side surface facing toward said side cover of said cover member,
said actuation member comprises two openings through which said first and second rod members pass respectively, and
an edge portion of each of said openings comprises an engagement blade configured to engage with said engagement groove.

16. The file according to claim 3, wherein
said first and second rod members each have a square cross section,
a plurality of said engagement grooves are formed on a side surface of said first rod member that is facing said second rod member,
a plurality of said engagement grooves are formed on a side surface of said second rod member that is facing said first rod member, and
said actuation member comprises a pair of engagement blades that are configured to engage with said engagement grooves of said first and second rod members.

17. The file according to claim 3, wherein
said locking mechanism comprises a pair of inclined guide surfaces formed on said pressure plate parallel to a direction that intersects said engagement grooves at an acute angle, and
said actuation member comprises a pair of guided portions that are guided respectively by said pair of inclined guide surfaces and an engagement blade parallel to said engagement configured groove that is to engage with said engagement groove from a direction that intersect said engagement groove at an acute angle.
